(19) United States
(12) Patent Application Publication
(10) Pub. No.: US 2022/0292378 A1
(43) Pub. Date: Sep. 15, 2022

(54) PREPROCESSING OF TIME SERIES DATA AUTOMATICALLY FOR BETTER AI

(71) Applicant: International Business Machines Corporation, Armonk, NY (US)

(72) Inventors: Mansoor Ahmed, BANGALORE (IN); Sattwati Kundu, Bangalore (IN); Raghunath E Nair, Bangalore (IN); GEETHA Adinarayan, Bangalore (IN)

(21) Appl. No.: 17/197,318

(22) Filed: Mar. 10, 2021

(51) Int. Cl. G06N 5/04; G06N 5/02; G06N 20/00

(52) U.S. Cl. CPC G06N 5/041; G06N 5/02; G06N 20/00

(57) ABSTRACT

In an approach for automatically updating the preprocessing of time series data for better AI, a processor identifies a set of characteristics from historic sensor data of a sensor, wherein the set of characteristics includes an original data granularity. A processor applies preprocessing to incoming sensor data of the sensor based on the set of characteristics. A processor, responsive to a pre-defined period of time passing, determines that a data granularity of the incoming sensor data has changed. A processor determines a new data granularity of the incoming sensor data. A processor updates the preprocessing of the incoming sensor data based on the new data granularity.

### BACKGROUND OF THE INVENTION

The present invention relates generally to the field of data processing, and more particularly to automatically updating the preprocessing of time series data.

Data preprocessing is a machine learning technique that involves transforming raw data into an understandable format. Real-world data is often incomplete, inconsistent, and/or lacking in certain behaviors or trends, and is likely to contain many errors. Data preprocessing is a proven method of resolving such issues.

Data preprocessing is an important step in any machine learning modelling process. The phrase “garbage in, garbage out” is particularly applicable to data mining and machine learning projects. Data-gathering methods are often loosely controlled, resulting in out-of-range values, impossible data combinations, and missing values, etc. Analyzing data that has not been carefully screened for such problems can produce misleading results. Thus, the representation and quality of data is first and foremost before running any analysis. Often, data preprocessing is the most important phase of a machine learning project.

If there is much irrelevant and redundant information present or noisy and unreliable data, then knowledge discovery during the training phase is more difficult. Data preparation and filtering steps can take considerable amount of processing time. Data preprocessing includes cleaning, instance selection, normalization, transformation, feature extraction and selection, etc.

Data pre-processing may affect the way in which outcomes of the final data processing can be interpreted. This aspect should be carefully considered when interpretation of the results is a key point.

### SUMMARY

Aspects of an embodiment of the present invention disclose a method, computer program product, and computer system for automatically updating the preprocessing of time series data based on a change in data granularity. A processor identifies a set of characteristics from historic sensor data of a sensor, wherein the set of characteristics includes an original data granularity. A processor applies preprocessing to incoming sensor data of the sensor based on the set of characteristics. A processor, responsive to a pre-defined period of time passing, determines that a data granularity of the incoming sensor data has changed. A processor determines a new data granularity of the incoming sensor data. A processor updates the preprocessing of the incoming sensor data based on the new data granularity.

In some aspects of an embodiment of the present invention, a processor feeds the set of characteristics into a knowledge graph as metadata for the sensor, wherein the sensor is stored as an entity in the knowledge graph, and wherein the knowledge graph comprises a plurality of entities associated with a plurality of sensors of a system.

In some aspects of an embodiment of the present invention, the set of characteristics further comprises statistical metrics, a seasonality, and outliers.

In some aspects of an embodiment of the present invention, a processor determines that the data granularity of the incoming sensor data has changed by using at least one of statistical techniques and machine learning for identifying outliers, a seasonality, and a frequency of the incoming sensor data.

In some aspects of an embodiment of the present invention, a processor updates the preprocessing of the incoming sensor data based on the new data granularity depending on whether the new data granularity is coarser or finer than the original data granularity. Responsive to the new data granularity being coarser than the original data granularity, a processor learns from the historic sensor data to fill in a missing pattern in future incoming sensor data by identifying missing time stamps and filling them based on a historic data pattern. Responsive to the new data granularity being finer than the original data granularity, a processor learns a finer data pattern based on the new data granularity of the incoming sensor data and fit the finer data pattern into the historic sensor data. A processor identifies hidden insights in the historic sensor data based on the finer data pattern.

### BRIEF DESCRIPTION OF THE DRAWINGS

FIG. 1 is a functional block diagram illustrating a distributed data processing environment, in accordance with an embodiment of the present invention.

FIG. 2 is a flowchart depicting operational steps of a preprocessing update program, for automatically updating the preprocessing of time series data based on a change in data granularity, in accordance with an embodiment of the present invention.

FIG. 3 depicts a block diagram of components of a computing device of the distributed data processing environment of FIG. 1, in accordance with an embodiment of the present invention.

### DETAILED DESCRIPTION

Embodiments of the present invention recognize that preprocessing of incoming data, such as from a sensor or Internet of Things (IoT) device (hereinafter “sensor” will refer to any type of sensor or IoT device), is completed based on a pre-defined data granularity of the incoming data. Data granularity denotes the level of detail of the data; the more granular the data, the more information contained in a particular data point. However, when the data granularity of the incoming data changes, i.e., goes from a lower data granularity to a higher data granularity or goes from a higher data granularity to a lower data granularity, the pre-processing might become invalid or insufficient causing valuable data patterns to be lost. The data granularity can change due to various reasons, e.g., replacement of sensors. If this incorrectly preprocessed streaming sensor data is fed into an Artificial Intelligence (AI) model, the AI model will output false and erroneous predictions or might fail to function at all. For example, if sensor data was incoming daily, but then, after updating to newer sensors, the sensor data starts coming in hourly, the data granularity has changed, and thus, the preprocessing of the incoming data needs to be updated to reflect the change.

When data granularity changes for incoming data received from, e.g., a previous sensor versus a newer sensor, two main problems can occur. First, an AI model trained on historical data with low data granularity might flag a newer value as an anomaly or false positive giving an erroneous prediction when that newer value could be within a data pattern that could be seen if the newer higher data granularity was taken into consideration. Second, standard preprocessing steps include defining a data granularity, e.g., daily, hourly, every 15 minutes, etc. Based on the defined data granularity of the previous sensor and how the previous sensor was recording (i.e., an aggregated value or at a given timestamp), missing values are imputed or aggregated by averaging or other means.

Embodiments of the present invention provide a system and method for automatically updating the preprocessing of time series data based on a change in data granularity. Embodiments of the present invention utilize machine-learning (ML) to understand the data granularity of incoming data from a sensor. Embodiments of the present invention further ensure data patterns are captured or maintained even after data granularity changes. Essentially, embodiments of the present invention enable automatic preprocessing of data based on streaming data analytics.

Embodiments of the present invention utilize a knowledge graph for defining a relationship between entities in a system, e.g., a plurality of sensors integrated into the physical environment of an enterprise comprising a plurality of floors in a plurality of buildings of the enterprise. The knowledge graph contains semantic annotations for each entity, in which the semantic annotations contain metadata including, but not limited to, properties of the sensors. Properties of the sensors include, but are not limited to, a data granularity, a seasonality, and missing values of the time series data collected/output by the sensor. Seasonality refers to a cycle that repeats at the same frequency over time, e.g., monthly or daily.

Embodiments of the present invention enable better AI through discovery of hidden insights. This technique is particularly beneficial when an existing sensor is changed or upgraded with a sensor capable of recording data with a finer data granularity. AI models are heavily dependent on the data being fed from the sensors, and hence this technique helps the AI models unearth hidden insights in the past data received from the future data received.

Implementation of embodiments of the invention may take a variety of forms, and exemplary implementation details are discussed subsequently with reference to the Figures.

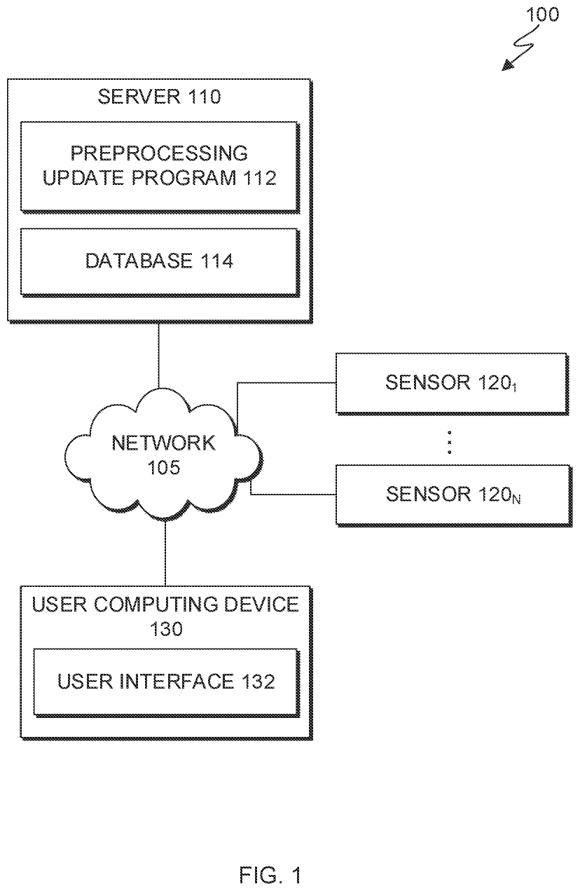

FIG. 1 is a functional block diagram illustrating a distributed data processing environment, generally designated 100, in accordance with one embodiment of the present invention. The term “distributed,” as used herein, describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 110, sensors 120_{1-N}, and user computing device 130, interconnected over network 105. Network 105 can be, for example, a telecommunications network, a local area network (LAN), a wide area network (WAN), such as the Internet, or a combination of the three, and can include wired, wireless, or fiber optic connections. Network 105 can include one or more wired and/or wireless networks capable of receiving and transmitting data, voice, and/or video signals, including multimedia signals that include voice, data, and video information. In general, network 105 can be any combination of connections and protocols that will support communications between server 110, sensors 120_{1-N}, user computing device 130, and other computing devices (not shown) within distributed data processing environment 100.

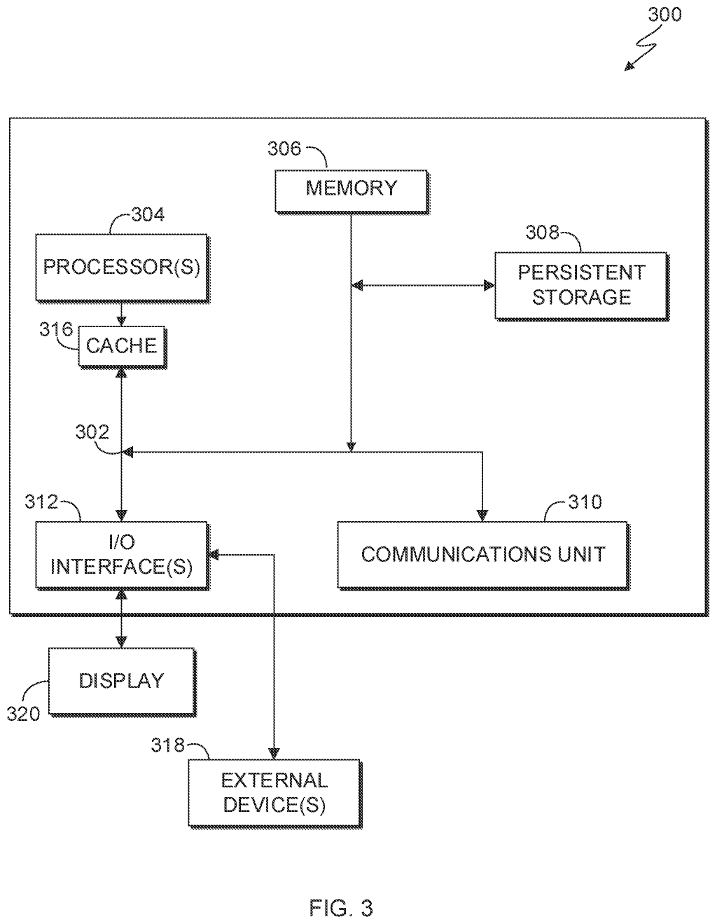

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any programmable electronic device capable of communicating with sensors 120_{1-N}, user computing device 130, and other computing devices (not shown) within distributed data processing environment 100 via network 105. In another embodiment, server 110 represents a computing system utilizing clustered computers and components (e.g., database server computers, application server computers, etc.) that act as a single pool of seamless resources when accessed within distributed data processing environment 100. Server 110 includes preprocessing update program 112 and database 114. Server 110 may include internal and external hardware components, as depicted and described in further detail with respect to FIG. 3.

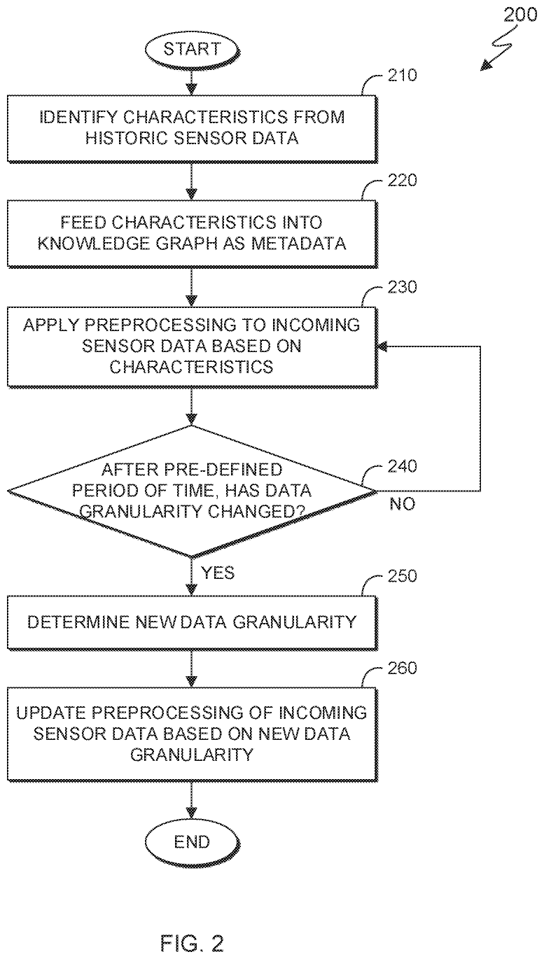

Preprocessing update program 112 operates to automatically update the preprocessing of time series data based on a change in data granularity of incoming sensor data. In an embodiment, preprocessing update program 112 periodically checks incoming sensor data to determine if the data granularity has changed. In an embodiment, preprocessing update program 112 updates preprocessing of incoming sensor data based on the new data granularity. If preprocessing update program 112 determines a new data granularity to be coarser than before, preprocessing update program 112 learns from historic data to fill in missing patterns. If preprocessing update program 112 determines a new data granularity to be finer than before, preprocessing update program 112 fits the finer data pattern into the historic data. In the depicted embodiment, preprocessing update program 112 is a standalone program. In another embodiment, preprocessing update program 112 may be integrated into another software product, such as an AI model program package. Preprocessing update program 112 is depicted and described in further detail with respect to FIG. 2.

Database 114 operates as a repository for data received, used, and/or output by preprocessing update program 112. Data received, used, and/or generated may include, but is not limited to, sensor data received by preprocessing update program 112; data granularity changes determined by preprocessing update program 112; missing values determined by preprocessing update program 112; and any other data received, used, and/or output by preprocessing update program 112. In some embodiments, database 114 contains a knowledge graph with semantic annotations, i.e., metadata, for each entity of an enterprise, in which the entities of the enterprise include a plurality of buildings with a plurality of floors with a plurality of sensors, e.g., sensors 120_{1-N}. Metadata associated with incoming sensor data from sensors 120_{1-N} is stored in the knowledge graph in database 114, in which the metadata can include, but is not limited to, statistical metrics of the data (mean, median, standard deviation, etc.), seasonality of the data, and outliers of the data. Database 114 can be implemented with any type of storage device capable of storing data and configuration files that can be accessed and utilized by server 110, such as a hard disk drive, a database server, or a flash memory. In an embodiment, database 114 is accessed by data granularity update program 112 to store and/or to access the data. In the depicted embodiment, database 114 resides on server 110. In another embodiment, database 114 may reside on another computing device, server, cloud server, or spread across multiple devices elsewhere (not shown) within distributed data processing environment 100, provided that data granularity update program 112 has access to database 114.

The present invention may contain various accessible data sources, such as database 114, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Preprocessing update program 112 enables the authorized and secure processing of personal data.

Preprocessing update program 112 provides informed consent, with notice of the collection of personal and/or confidential company data, allowing the user to opt in or opt out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Preprocessing update program 112 provides information regarding personal and/or confidential company data and the nature (e.g., type, scope, purpose, duration, etc.) of the processing. Preprocessing update program 112 provides the user with copies of stored personal and/or confidential company data. Preprocessing update program 112 allows the correction or completion of incorrect or incomplete personal and/or confidential company data. Preprocessing update program 112 allows for the immediate deletion of personal and/or confidential company data.

Sensors 120_{1-N}, hereinafter sensors 120, operate as any type of sensor that collects data. As used herein, N represents a positive integer, and accordingly the number of scenarios implemented in a given embodiment of the present invention is not limited to those depicted in FIG. 1. A sensor is a device that detects or measures a physical property and then records or otherwise responds to that property, such as vibration, chemicals, radio frequencies, environment, weather, humidity, light, etc. In some embodiments, sensors 120 represent a plurality of sensors integrated into the physical environment of an enterprise comprising a plurality of floors in a plurality of buildings of the enterprise.

User computing device 130 operates as a computing device associated with a user on which the user can interact with preprocessing update program 112 through an application user interface. In the depicted embodiment, user computing device 130 includes an instance of user interface 132. In an embodiment, user computing device 130 can be a laptop computer, a tablet computer, a smart phone, a smart watch, an e-reader, smart glasses, wearable computer, or any programmable electronic device capable of communicating with various components and devices within distributed data processing environment 100, via network 105. In general, user computing device 130 represents one or more programmable electronic devices or combination of programmable electronic devices capable of executing machine readable program instructions and communicating with other computing devices (not shown) within distributed data processing environment 100 via a network, such as network 105. User computing device 130 may include internal and external hardware components, as depicted and described in further detail with respect to FIG. 3.

User interface 132 provides an interface between preprocessing update program 112 on server 110 and a user of user computing device 130. In one embodiment, user interface 132 is a mobile application software. Mobile application software, or an “app,” is a computer program designed to run on smart phones, tablet computers, and other mobile computing devices. In one embodiment, user interface 132 may be a graphical user interface (GUI) or a web user interface (WUI) that can display text, documents, web browser windows, user options, application interfaces, and instructions for operation, and include the information (such as graphic, text, and sound) that a program presents to a user and the control sequences the user employs to control the program. User interface 132 enables a user of user computing device 130 to view and/or manage output of preprocessing update program 112.

FIG. 2 is a flowchart 200 depicting operational steps of preprocessing update program 112, for automatically updating the preprocessing of time series data based on a change in data granularity, in accordance with an embodiment of the present invention. It should be appreciated that the process depicted in FIG. 2 illustrates one possible iteration of preprocessing update program 112, which can be done for each sensor of a system, e.g., sensors 120. It should also be appreciated that the process depicted in FIG. 2 can be done in parallel to enable automatic preprocessing updates for multiple sensors of a system simultaneously.

In step 210, preprocessing update program 112 identifies a set of characteristics from historic sensor data. In an embodiment, preprocessing update program 112 identifies a set of characteristics from historic sensor data received from a sensor. The set of characteristics includes, but is not limited to, data granularity, statistical metrics (i.e., mean, median, standard deviation, etc.), seasonality, outliers, and any trends. In an embodiment, preprocessing update program 112 identifies the set of characteristics from historic sensor data using statistical techniques and/or machine learning for identifying outliers, seasonality, frequency, trends, etc.

In step 220, preprocessing update program 112 feeds the set of characteristics into knowledge graph as metadata. In an embodiment, preprocessing update program 112 feeds and stores the set of characteristics of the sensor in a knowledge graph, in which the sensor is an entity and the set of characteristics are stored as metadata of the entity.

In step 230, preprocessing update program 112 applies preprocessing to incoming sensor data. In an embodiment, based on the set of characteristics, preprocessing update program 112 applies preprocessing to incoming sensor data. The preprocessing process may be a defined logic when the sensor is first time onboarded/installed that involves, for example, imputation of missing values by average, maximum, or any other metric. Preprocessing involves transforming raw data, i.e., the incoming sensor data, into an understandable format for an AI model to use.

In decision 240, after a pre-defined period of time, preprocessing update program 112 determines whether the data granularity has changed. In an embodiment, preprocessing update program 112 periodically determines whether the data granularity of the sensor has changed. In an embodiment, responsive to a pre-defined period of time passing, preprocessing update program 112 determines whether the data granularity of the sensor has changed. In an embodiment, preprocessing update program 112 enables a user to set the pre-defined period of time, e.g., a user of user computer device 130 can set the pre-defined period of time to be one month, six months, one year, etc. In an embodiment, preprocessing update program 112 determines whether the data granularity for the sensor has changed using statistical techniques and/or machine learning for identifying outliers, seasonality, frequency, trends, etc. of the incoming data, and therefore, the data granularity of the incoming data.

If preprocessing update program 112 determines the data granularity has changed (decision 240, YES branch), then preprocessing update program 112 proceeds to step 250 to determine the new data granularity. If preprocessing update program 112 determines the data granularity has not changed (decision 240, NO branch), then preprocessing update program 112 proceeds back to step 230 and continues to apply the preprocessing to incoming sensor data, and waits another pre-defined period of time before determining whether the data granularity has changed again.

In step 250, preprocessing update program 112 determines the new data granularity. In an embodiment, preprocessing update program 112 determines the new data granularity to be coarser or finer than the original data granularity. In an embodiment, preprocessing update program 112 checks historic data pattern to determine whether the sensor was recording as an aggregated value (maximum, sum, or average for the day) or at a given timestamp (value measured at 8:00 AM daily). In an embodiment, preprocessing update program 112 updates metadata for entity in knowledge graph associated with the sensor with the new data granularity.

In step 260, preprocessing update program 112 updates the preprocessing of incoming sensor data based on the new data granularity. In an embodiment, preprocessing update program 112 updates the preprocessing logic for future incoming sensor data by revisiting the statistical metric computations and redefining a seasonality based on the new data granularity. In an embodiment, responsive to determining the new data granularity is coarser than the old data granularity, preprocessing update program 112 learns from the historic data to fill in missing pattern by identifying missing time stamps and filling them based on historic data pattern. In an embodiment, responsive to determining the new data granularity is finer than the old data granularity, preprocessing update program 112 fits finer data pattern learned based on the new finer data granularity of the latest incoming data into the historic data. By fitting this new finer data pattern into the historic data, hidden insights in the historic data can be discovered.

FIG. 3 depicts a block diagram of components of computing device 300, suitable for server 110 and/or user computing device 130 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing device 300 includes communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Programs may be stored in persistent storage 308 and in memory 306 for execution and/or access by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Programs may be downloaded to persistent storage 308 through communications unit 310.

I/O interface(s) 312 allows for input and output of data with other devices that may be connected to server 110 and/or user computing device 130. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying, by one or more processors, a set of characteristics from historic sensor data of a sensor, wherein the set of characteristics includes an original data granularity;
applying, by the one or more processors, preprocessing to incoming sensor data of the sensor based on the set of characteristics;
responsive to a pre-defined period of time passing, determining, by the one or more processors, that a data granularity of the incoming sensor data has changed;
determining, by the one or more processors, a new data granularity of the incoming sensor data; and
updating, by the one or more processors, the preprocessing of the incoming sensor data based on the new data granularity.

2. The computer-implemented method of claim 1, further comprising:
feeding, by the one or more processors, the set of characteristics into a knowledge graph as metadata for the sensor, wherein the sensor is stored as an entity in the knowledge graph, and wherein the knowledge graph comprises a plurality of entities associated with a plurality of sensors of a system.

3. The computer-implemented method of claim 1, wherein the set of characteristics further comprises statistical metrics, a seasonality, and outliers.

4. The computer-implemented method of claim 1, wherein determining that the data granularity of the incoming sensor data has changed comprises:
using, by the one or more processors, at least one of statistical techniques and machine learning for identifying outliers, a seasonality, and a frequency of the incoming sensor data.

5. The computer-implemented method of claim 1, wherein updating the preprocessing of the incoming sensor data based on the new data granularity further comprises:
responsive to the new data granularity being coarser than the original data granularity, learning, by the one or more processors, from the historic sensor data to fill in a missing pattern in future incoming sensor data by identifying missing time stamps and filling them based on a historic data pattern.

6. The computer-implemented method of claim 1, wherein updating the preprocessing of the incoming sensor data based on the new data granularity comprises:
responsive to the new data granularity being finer than the original data granularity, learning, by the one or more processors, a finer data pattern based on the new data granularity of the incoming sensor data and fit the finer data pattern into the historic sensor data.

7. The computer-implemented method of claim 6, further comprising:
identifying, by the one or more processors, hidden insights in the historic sensor data based on the finer data pattern.

8. A computer program product comprising:
one or more computer readable storage media and program instructions collectively stored on the one or more computer readable storage media, the stored program instructions comprising:
program instructions to identify a set of characteristics from historic sensor data of a sensor, wherein the set of characteristics includes an original data granularity;
program instructions to apply preprocessing to incoming sensor data of the sensor based on the set of characteristics;
responsive to a pre-defined period of time passing, program instructions to determine that a data granularity of the incoming sensor data has changed;
program instructions to determine a new data granularity of the incoming sensor data; and
program instructions to update the preprocessing of the incoming sensor data based on the new data granularity.

9. The computer program product of claim 8, further comprising:
program instructions to feed the set of characteristics into a knowledge graph as metadata for the sensor, wherein the sensor is stored as an entity in the knowledge graph, and wherein the knowledge graph comprises a plurality of entities associated with a plurality of sensors of a system.

10. The computer program product of claim 8, wherein the set of characteristics further comprises statistical metrics, a seasonality, and outliers.

11. The computer program product of claim 8, wherein the program instructions to determine that the data granularity of the incoming sensor data has changed comprise:
program instructions to use at least one of statistical techniques and machine learning for identifying outliers, a seasonality, and a frequency of the incoming sensor data.

12. The computer program product of claim 8, wherein the program instructions to update the preprocessing of the incoming sensor data based on the new data granularity further comprise:
responsive to the new data granularity being coarser than the original data granularity, program instructions to learn from the historic sensor data to fill in a missing pattern in future incoming sensor data by identifying missing time stamps and filling them based on a historic data pattern.

13. The computer program product of claim 8, wherein the program instructions to update the preprocessing of the incoming sensor data based on the new data granularity comprise:
responsive to the new data granularity being finer than the original data granularity, program instructions to learn a finer data pattern based on the new data granularity of the incoming sensor data and fit the finer data pattern into the historic sensor data.

14. The computer program product of claim 13, further comprising:
program instructions to identify hidden insights in the historic sensor data based on the finer data pattern.

15. A computer system comprising:
one or more computer processors;
one or more computer readable storage media;
program instructions collectively stored on the one or more computer readable storage media for execution by at least one of the one or more computer processors, the stored program instructions comprising:
program instructions to identify a set of characteristics from historic sensor data of a sensor, wherein the set of characteristics includes an original data granularity;
program instructions to apply preprocessing to incoming sensor data of the sensor based on the set of characteristics;
responsive to a pre-defined period of time passing, program instructions to determine that a data granularity of the incoming sensor data has changed;
program instructions to determine a new data granularity of the incoming sensor data; and
program instructions to update the preprocessing of the incoming sensor data based on the new data granularity.

16. The computer system of claim 15, further comprising:
program instructions to feed the set of characteristics into a knowledge graph as metadata for the sensor, wherein the sensor is stored as an entity in the knowledge graph, and wherein the knowledge graph comprises a plurality of entities associated with a plurality of sensors of a system.

17. The computer system of claim 15, wherein the program instructions to determine that the data granularity of the incoming sensor data has changed comprise:
program instructions to use at least one of statistical techniques and machine learning for identifying outliers, a seasonality, and a frequency of the incoming sensor data.

18. The computer system of claim 15, wherein the program instructions to update the preprocessing of the incoming sensor data based on the new data granularity further comprise:
responsive to the new data granularity being coarser than the original data granularity, program instructions to learn from the historic sensor data to fill in a missing pattern in future incoming sensor data by identifying missing time stamps and filling them based on a historic data pattern.

19. The computer system of claim 15, wherein the program instructions to update the preprocessing of the incoming sensor data based on the new data granularity comprise:
responsive to the new data granularity being finer than the original data granularity, program instructions to learn a finer data pattern based on the new data granularity of the incoming sensor data and fit the finer data pattern into the historic sensor data.

20. The computer system of claim 19, further comprising:
program instructions to identify hidden insights in the historic sensor data based on the finer data pattern.
